(19) United States
(12) Patent Application Publication
(10) Pub. No.: US 2005/0008347 A1
(43) Pub. Date: Jan. 13, 2005

(54) Method of processing subtitle stream, reproducing apparatus and information storage medium thereof

(75) Inventors: Kil-soo Jung, Gyeonggi-do (KR); Seong-jin Moon, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/843,670

(22) Filed: May 12, 2004

(30) Foreign Application Priority Data
May 17, 2003 (KR) 2003-31449

(51) Int. Cl. H04N 5/781

(52) U.S. Cl. 386/125; 386/131

(57) ABSTRACT

A method of processing a subtitle stream, a reproducing apparatus, and an information storage medium thereof. The information storage medium includes an AV stream, a subtitle stream which is displayed with the AV stream, and conversion information which indicates an instruction to change a format of the subtitle stream.

### CROSS-REFERENCE TO RELATED APPLICATIONS

This application claims the benefit of Korean Patent Application No. 2003-31449, filed on May 17, 2003, in the Korean Intellectual Property Office, the disclosure of which is incorporated herein in its entirety by reference.

### BACKGROUND OF THE INVENTION

1. Field of the Invention

The present invention relates to the processing of a subtitle stream displayed with an AV stream, and more particularly, to a method of processing a subtitle stream to be displayed with an AV stream according to a variety of display resolution and aspect ratios, a reproducing apparatus, and an information storage medium thereof.

2. Description of the Related Art

With the development of digital broadcasting, high resolution, high definition (HD) moving pictures have became popular. HD moving pictures are stored and reproduced using information storage media such as optical discs.

Conventional DVD-Video contains a subtitle with a video title. The video title is recorded as an AV stream for providing moving pictures having a standard definition (SD) picture quality. The sub-title is graphic data for displaying a movie subtitle, and is multiplexed and recorded with the AV stream.

The AV stream has an SD picture quality but the size thereof is comparatively large. Thus, when recording the AV stream according to a variety of resolution or aspect ratios, a large storage space is required. For this reason, conventional DVD-Video players convert the AV stream according to a resolution or aspect ratio of a display device. However, since the size of an SD subtitle stream for the AV stream having an SD picture quality is comparatively small, conventional DVD-Video has separate subtitle streams, that is, a subtitle stream for an aspect ratio of 16:9 and a subtitle stream for an aspect ratio of 4:3, according to the aspect ratio of a display device, and the separate aspect ratios are used according to a user's selection.

However, it is inefficient to provide an HD subtitle stream corresponding to an HD moving picture stream according to each resolution and aspect ratio of a variety of display devices and to record the HD subtitle stream on an information storage medium with an AV stream having a HD picture quality, because the sizes of the AV stream and subtitle stream for the HD picture quality are much larger than these of the AV stream and subtitle stream for the SD picture quality. Further, in view of resolution and aspect ratios of a variety of display devices, providing each subtitle stream causes a disc manufacturer to perform authoring repeatedly.

### SUMMARY OF THE INVENTION

The present invention provides a method of processing a subtitle stream to use a storage space of an information storage medium more effectively, a reproducing apparatus, and an information storage medium thereof. According to an aspect of the present invention, there is an information storage medium comprising an AV stream; a subtitle stream, which is displayed with the AV stream; and conversion information, which indicates an instruction to change a format of the subtitle stream.

According to another aspect of the present invention, there is a method of processing a subtitle stream, the method comprising: checking conversion information of a subtitle stream to be displayed with an AV stream; and changing a format of the subtitle stream based on the checked conversion information.

According to one aspect of the present invention, checking the conversion information of the subtitle stream comprises checking the conversion information contained in the subtitle stream multiplexed with the AV stream.

According to various aspects of the present invention, changing the format of the subtitle stream comprises down-sampling or up-sampling the subtitle stream based on sampling information as the conversion information, displaying the subtitle stream on a display screen using position information as the conversion information, and/or displaying the subtitle stream on black bars of the letter box when the AV stream is displayed in a letter box format.

According to another aspect of the present invention, there is a reproducing apparatus comprising a controller, to control changing a format of a subtitle stream based on conversion information; and a signal processor, to change the format of the subtitle stream corresponding to an AV stream according to the control of the controller.

According to another aspect of the present invention, the controller controls changing the format of the subtitle stream based on the conversion information contained in the subtitle stream multiplexed with the AV stream.

According to another aspect of the present invention, the signal processor performs down-sampling or up-sampling on the subtitle stream based on the changed format, outputs the subtitle stream to be displayed at a position of a display screen based on the changed format, or outputs the subtitle stream to be displayed on black bars of a letter box when the AV stream is displayed in a letter box format.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 schematically shows a reproducing system including a reproducing apparatus according to an aspect of the present invention;

FIG. 2 is a functional block diagram of a reproducing apparatus shown in FIG. 1;

FIGS. 3A through 3D show an AV stream and a subtitle stream recorded on a disc according to another aspect of the present invention;

FIG. 4 shows a method of processing a subtitle based on conversion information according to still another aspect of the present invention; and

FIG. 5 depicts the method shown in FIG. 4 for additional clarification.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

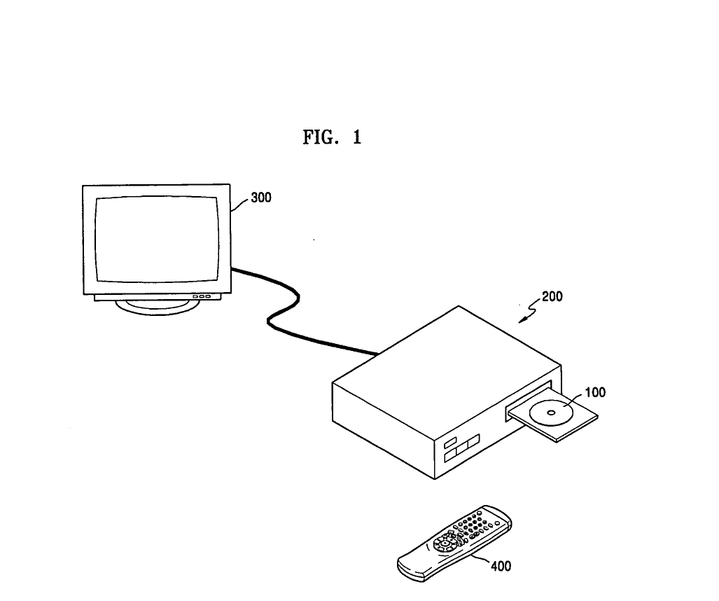

FIG. 1 schematically shows a reproducing system including a reproducing apparatus according to an aspect of the present invention. Referring to FIG. 1, the reproducing system includes a disc 100, a reproducing apparatus 200, a TV 300, and a remote controller 400. An AV stream, a subtitle stream, and conversion information are recorded on the disc 100. The conversion information is information having instructions on how to change the format of the subtitle stream. In another aspect of the present invention, the conversion information further includes information indicating the position at which a subtitle is to be displayed on a display screen. The conversion information will be described in detail later. The TV 300 is a display device that supports HD and/or SD resolution, at least one aspect ratio selected from 16:9 and 4:3, and/or a letter box-type screen, according to various aspects of the present invention.

A user's control instruction is input into the remote controller 400, and the remote controller 400 transmits the control instruction to the reproducing apparatus 200. The reproducing apparatus 200 reads an AV stream and a subtitle stream, selected by the user's control instruction, from the disc 100 and reproduces the read AV stream and subtitle stream. The reproducing apparatus 200 changes the format of the subtitle stream based on the conversion information and transmits the subtitle stream to the TV 300. The TV 300 displays the subtitle stream corresponding to the AV stream received from the reproducing apparatus 200.

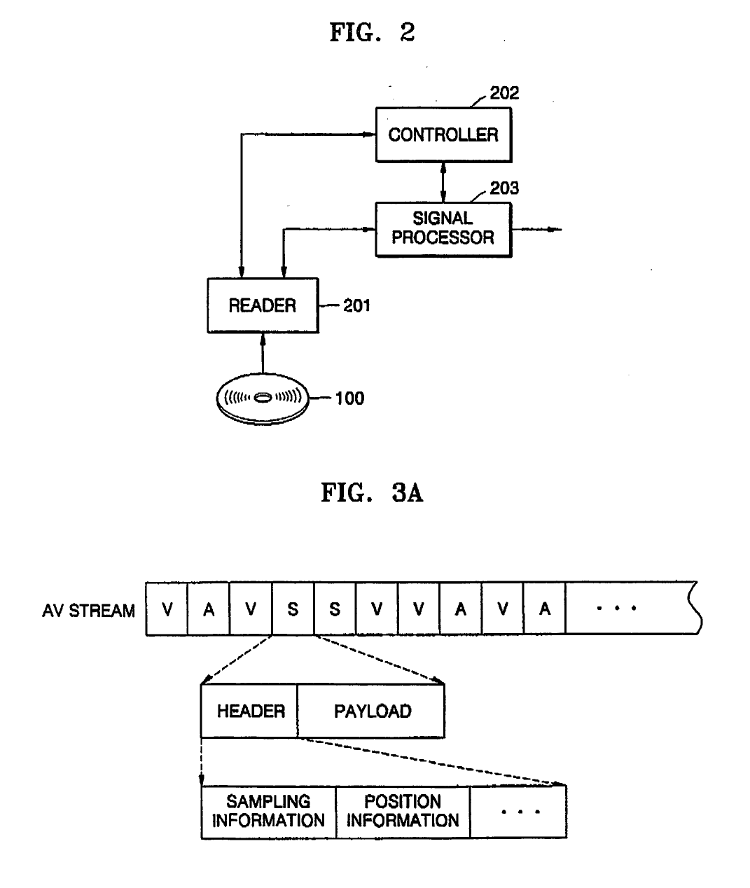

FIG. 2 is a functional block diagram of the reproducing apparatus 200 shown in FIG. 1. Referring to FIG. 2, the reproducing apparatus 200 includes a reader 201, a controller 202, and a signal processor 203. The reader 201 reads and outputs an AV stream, a subtitle stream, and conversion information from the disc 100. The controller 202 interprets the conversion information and gives a format changing instruction to change the format of the subtitle stream according to an interpretation result to the signal processor 203. The signal processor 203 changes the format of the subtitle stream according to the format changing instruction. Further details of the format change will be described later.

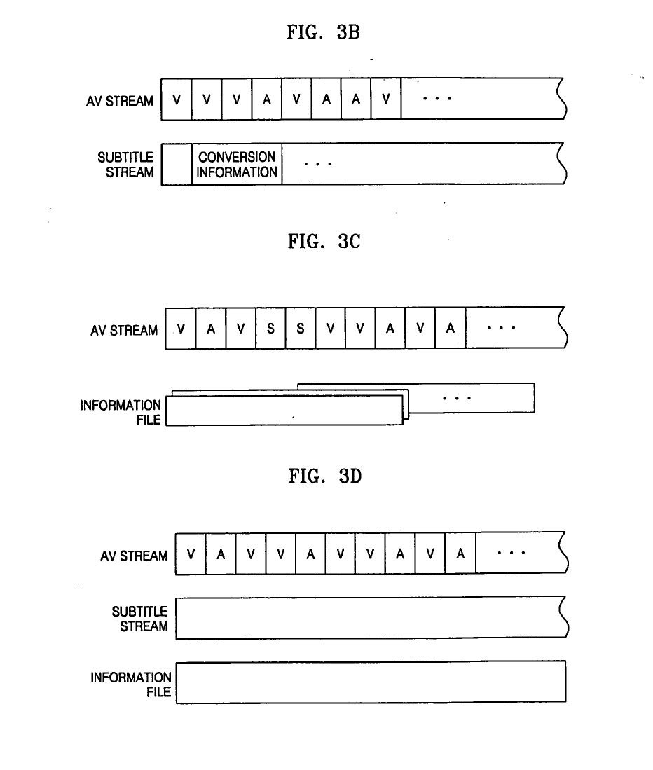

FIGS. 3A through 3D show the AV stream and the subtitle stream recorded on the disc 100 according to another aspect of the present invention. Referring to FIG. 3A, the subtitle stream is recorded with the AV stream on the disc 100. V is a video pack in which video data is contained, A is an audio pack in which audio data is contained, and S is a subtitle pack in which subtitle data is contained. The video pack, the audio pack, and the subtitle pack may be multiplexed to be synchronized and reproduced. The subtitle pack comprises a header in which synchronization timing information and position information on a display screen are contained, and a payload in which graphic data for composing a subtitle is contained. Sampling information and position information which are conversion information, are recorded in the header. The sampling information is information indicating an instruction to perform up-sampling or down-sampling on a subtitle stream according to the resolution and aspect ratio of the display screen. For example, in order to display the subtitle stream for an aspect ratio of 16:9 having HD resolution on a SD display device, an instruction to perform down-sampling horizontally and vertically is given. The position information is information indicating the position at which a subtitle is to be displayed on the display screen. For example, when the AV stream is displayed on a letter-box type screen, an instruction to display the subtitle on the black bars of the letter box is given. According to an aspect of the present invention, the position at which the subtitle is to be displayed is a predetermined position.

According to another aspect of the present invention, selection information indicating whether down-sampling conversion for a letter box is performed on a presentation composition segment (PCS) of a subtitle stream containing information on the position and display of the subtitle that can be displayed on a display screen, may be recorded in the header. Since a PCS structure as defined in conventional DVD-Video includes information on where the subtitle is to be displayed on the display screen, it is enough to further record only information indicating whether down-sampling conversion for the letter box is performed on the subtitle stream using a reserved area.

Referring to FIG. 3B, the subtitle stream is recorded separately from the AV stream on the disc 100. As shown in FIG. 3A, V is a video pack in which video data is contained and A is an audio pack in which audio data is contained. The video pack and the audio pack may be multiplexed to be synchronized and reproduced. Conversion information is recorded in the subtitle stream. The conversion information includes the sampling information shown in FIG. 3A and may further include position information.

Referring to FIG. 3C, the subtitle stream is recorded with the AV stream on the disc 100, as shown in FIG. 3A. FIG. 3C differs from FIG. 3A in that in FIG. 3C, conversion information is recorded in an information file provided in each subtitle stream. The information file is a separate file in which attribute information of the subtitle stream and entry point information are recorded. Information indicating whether down-sampling for a letter box is to be performed on the subtitle stream is recorded as conversion information in the information file. If down-sampling does not need to be performed, the conversion information includes position information in which the subtitle is displayed at a predetermined position of a display screen having an aspect ratio of 4:3 and SD resolution. In this case, the position at which the subtitle is displayed is in the black bars.

Referring to FIG. 3D, the subtitle stream is recorded separately from the AV stream on the disc 100, as shown in FIG. 3B. FIG. 3D differs from FIG. 3B in that in FIG. 3D, conversion information is recorded in an information file that is separate from each subtitle stream.

A method of processing a subtitle stream according to an aspect of the present invention will now be described based on the above-described configuration.

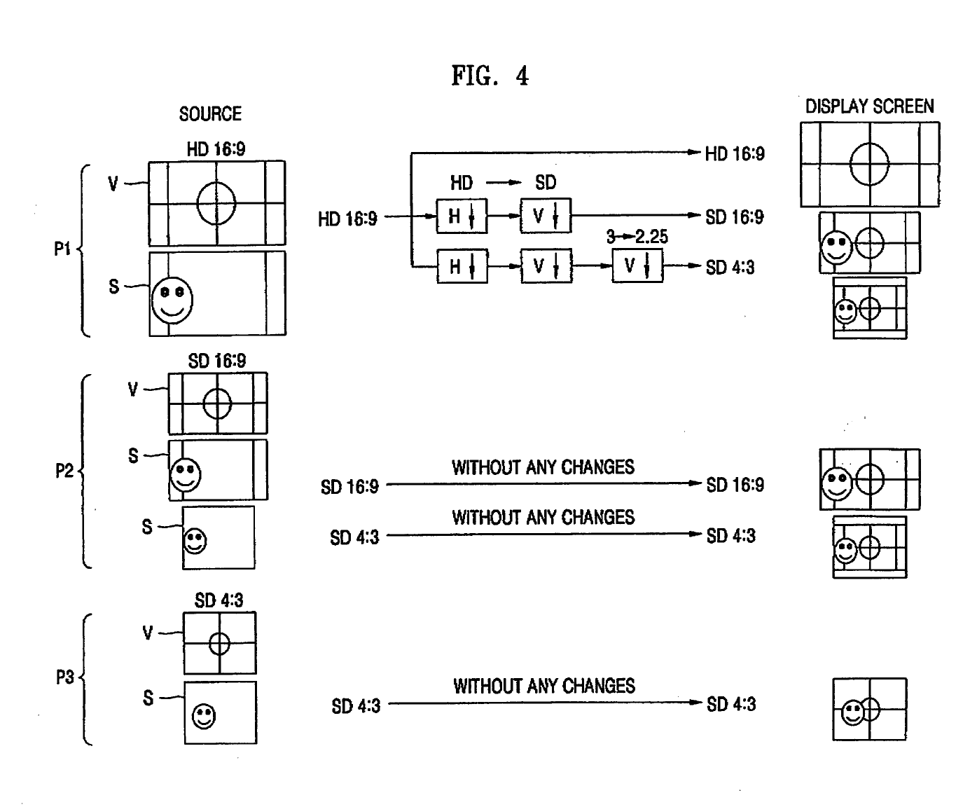

FIG. 4 shows a method of processing a subtitle based on conversion information according to an aspect of the present invention. Referring to a first picture P1 of FIG. 4, sources (AV stream and subtitle stream) recorded on the disc 100 are processed and displayed on a display screen according to a resolution and an aspect ratio of a display device. An AV stream having an aspect ratio of 16:9 and HD resolution and a subtitle stream having an aspect ratio of 16:9 and HD resolution are displayed without any changes on a display device that supports the same HD resolution. On the other hand, the AV stream having an aspect ratio of 16:9 and HD resolution and the subtitle stream having an aspect ratio of 16:9 and HD resolution are displayed on a display device that supports an aspect ratio of 16:9 and SD resolution after down-sampling conversion is performed horizontally and vertically on the subtitle stream to change the HD resolution to the SD resolution. In addition, the AV stream having an aspect ratio of 16:9 and HD resolution and the subtitle stream having an aspect ratio of 16:9 and HD resolution are displayed on a display device that supports an aspect ratio of 4:3 and SD resolution after down-sampling conversion is performed on the subtitle stream to have the SD resolution and then is further performed vertically according to the form of the letter box.

Referring to a second picture P2 of FIG. 4, which represents the conventional DVD-Video, subtitle streams each having aspect ratios of 16:9 and 4:3 are used as sources that support an aspect ratio of 16:9 and SD resolution. The sources are displayed on a display device that supports HD resolution after up-sampling conversion is performed on the subtitle stream. Meanwhile, the source that supports an aspect ratio of 16:9 is displayed on a display device that supports an aspect ratio of 16:9 and SD resolution, and the source that supports an aspect ratio of 4:3 is displayed on a display device that supports an aspect ratio of 4:3 and SD resolution.

Referring to a third picture P3 of FIG. 4, sources support an aspect ratio of 4:3 and SD resolution. In this case, the sources are displayed on a display device that supports an upper resolution after up-sampling conversion is performed on a subtitle stream, and the sources are displayed on right and left black bars of a display device that supports an aspect ratio of 16:9 and SD resolution. The sources can be displayed without any changes on a display device that supports an aspect ratio of 4:3 and SD resolution.

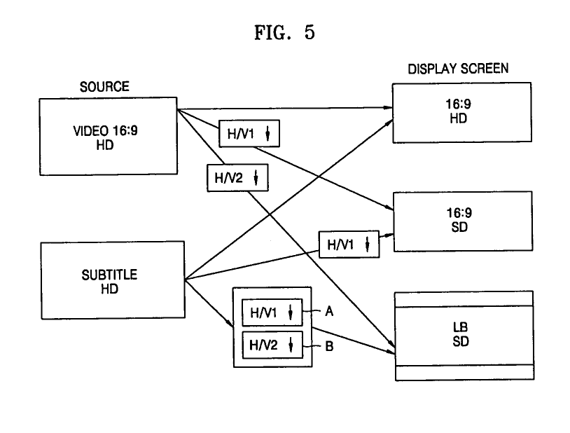

FIG. 5 depicts the method shown in the first picture P1 of FIG. 4 for additional clarification. Referring to FIG. 5, H/V1 ↓ represents down-sampling to change HD resolution to SD resolution, and H/V2 ↓ represents down-sampling a source down-sampled by H/V1 ↓ to the SD resolution vertically to be displayed on a letter box-type screen. Selection information for determining whether an HD subtitle source is down-sampled by H/V1 ↓ or H/V2 ↓ to a 4:3 aspect ratio and SD resolution may be contained in the conversion information as sampling information. In general, when H/V2 ↓ down-sampling is performed, since an AV stream is down-sampled to the SD resolution, there is no problem in screen display without the above-described selection information. However, a subtitle is classified into two types according to how it is to be used. One is a subtitle that should be exactly overlaid on an AV image like button-shaped graphics. The other is a subtitle that is overlaid on a position of a video screen obtained from an AV stream, such as with subtitle graphics. When the resolution of an HD AV stream is decreased to SD resolution so as to be displayed on a display device that supports an aspect ratio of 4:3, and SD resolution and down-sampling is further performed vertically in the form of the letter box so as to maintain an aspect ratio of 16:9, down-sampling should be performed once more on the former subtitle, as in the AV stream, to be exactly overlaid on the video screen. However, since the latter subtitle, such as the subtitle graphics, is not necessarily exactly overlaid on the video screen, it is more preferable that down-sampling is performed to the SD resolution only once. This is because subtitles which have been twice down-sampled vertically to the form of the letter box are harder to read than subtitles on which down-sampling has not been performed. The subtitles on which vertical down-sampling has not been performed are displayed on the black bars formed in the letter box so that the black bars can be utilized, and the second one down-sampling is omitted.

Thus, in order to display all HD subtitle streams on a display device that supports an aspect ratio of 4:3 and SD resolution, down-sampling, such as H/V2↓, does not need to be performed an additional time. Thus, selection information for determining whether the HD subtitle is displayed on the display device that supports an aspect ratio of 4:3 and SD resolution by H/V1↓or H/V2↓ down-sampling using conversion information, can be recorded in the header.

As described above, in the method of processing a subtitle stream, a reproducing apparatus, and an information storage medium thereof according to the preseOnt invention, a storage space for the information storage medium can be used more effectively. In particular, selection information on down-sampling is added as conversion information to the subtitle stream, such that the image processing of the reproducing apparatus is simplified and black bars formed when an AV image is displayed in the form of a letter box are used effectively. Further, the reproducing apparatus of the present invention omits complicated conversion by using the selection information indicating whether down-sampling for the letter box is to be performed on the subtitle stream, such that burdens on the reproducing apparatus are removed. A subtitle having higher readability is thereby provided to a user.

Although a few embodiments of the present invention have been shown and described, it would be appreciated by those skilled in the art that changes may be made in this embodiment without departing from the principles and spirit of the invention, the scope of which is defined in the claims and their equivalents.

1. An information storage medium comprising:
an AV stream;
a subtitle stream, to be displayed with the AV stream; and
conversion information having an instruction to change a format of the subtitle stream.

2. The information storage medium of claim 1, wherein the conversion information comprises sampling information to perform up-sampling or down-sampling on the subtitle stream.

3. The information storage medium of claim 1, wherein the conversion information comprises sampling information to perform up-sampling or down-sampling on the subtitle stream so as to change at least one of resolution and aspect ratio of the subtitle stream.

4. The information storage medium of claim 2, wherein the conversion information further includes position information to display the subtitle stream in a predetermined location on a display screen.

5. The information storage medium of claim 2, wherein the conversion information further includes selection information on down-sampling.

6. The information storage medium of claim 1, wherein the subtitle stream is multiplexed with the AV stream.

7. The information storage medium of claim 1, wherein the conversion information is contained in the subtitle stream.

8. The information storage medium of claim 1, wherein the conversion information is contained in a presentation composition segment in the subtitle stream.

9. The information storage medium of claim 1, wherein the conversion information exists separately from the subtitle stream and is contained in an information file in which information pertaining to the subtitle stream is recorded.

10. The information storage medium of claim 9, wherein the information file includes attribute information of the subtitle stream.

11. A method of processing a subtitle stream to be displayed with an AV stream, the method comprising:
checking conversion information contained in the subtitle stream; and
changing a format of the subtitle stream based on the checked conversion information.

12. The method of claim 11, wherein the conversion information contained in the subtitle stream is multiplexed with the AV stream.

13. The method of claim 11, wherein the conversion information is sampling information, and the format of the subtitle stream is changed by down-sampling or up-sampling the subtitle stream.

14. The method of claim 11, wherein the conversion information is position information, and the changing the format of the subtitle stream comprises displaying the subtitle stream on a display screen.

15. The method of claim 14, wherein the subtitle stream is displayed on the display screen having an aspect ratio of 4:3 and an SD resolution.

16. The method of claim 14, wherein the changing the format of the subtitle stream further comprises displaying the AV stream in a letter box format, and displaying the subtitle stream on black bars of the letter box.

17. A reproducing apparatus comprising:
a controller, which instructs to change a format of a subtitle stream based on conversion information; and
a signal processor, which changes the format of the subtitle stream corresponding to an AV stream according to a format changing instruction of the controller.

18. The apparatus of claim 17, wherein the controller gives an instruction to the format changing instruction to the signal processor based on the conversion information contained in the subtitle stream multiplexed with the AV stream.

19. The apparatus of claim 17, wherein the signal processor performs down-sampling or up-sampling on the subtitle stream according to the format changing instruction.

20. The apparatus of claim 17, wherein the signal processor outputs the subtitle stream to be displayed at a position of a display screen according to the format changing instruction.

21. The apparatus of claim 20, wherein the signal processor outputs the subtitle stream to be displayed on black bars of a letter box when the AV stream is displayed in a letter box format.

22. A reproducing apparatus to reproduce an AV stream and a corresponding subtitle stream on a display, when the subtitle stream contains conversion information, the reproducing apparatus comprising:
a signal processor to change a format of the subtitle stream;
a controller to control the changing of the format of the subtitle stream by the signal processor based on the conversion information.

23. The reproducing apparatus of claim 22, wherein the conversion information contained in the subtitle stream is multiplexed with the AV stream.

24. The reproducing apparatus of claim 23, wherein the multiplexed subtitle stream is divided into subtitle packs, the subtitle packs comprising:
a header in which synchronization timing information and position information are contained; and
a payload in which graphic data to compose a subtitle is contained.

25. The reproducing apparatus of claim 24, wherein information indicating whether down-sampling conversion is to be performed on the subtitle stream is stored in a reserved area of the header.

26. The reproducing apparatus of claim 22, wherein the signal processor changes the format of the subtitle stream by down-sampling or up-sampling the subtitle stream.

27. The reproducing apparatus of claim 22, wherein the subtitle stream with the changed format is output from the signal processor and displayed on the display in a predetermined position.

28. The reproducing apparatus of claim 22, wherein the subtitle stream with the changed format is output from the signal processor and displayed on the display in black bars when the AV stream is displayed in a letter box format.

29. A method of reproducing an AV stream and a corresponding subtitle stream from an optical disc, the method comprising:
reading the AV stream from the optical disc, the AV stream having a first AV resolution format and a first AV aspect ratio format;
reading the subtitle stream from the optical disc, the subtitle stream having a first subtitle resolution format and a first subtitle aspect ratio format;
determining a display resolution format and a display aspect ratio format at which the AV stream and the subtitle stream are to be displayed;
if the display resolution format is different from the first AV resolution format, down-sampling or up-sampling the AV stream to have a second AV resolution format that matches the display resolution format;
if the display resolution format is different from the first subtitle resolution format, down-sampling or up-sampling the subtitle stream to have a second subtitle resolution format that matches the display resolution format;
if the display aspect ratio format is different from the first AV aspect ratio format, down-sampling or up-sampling the AV stream to have a second AV aspect ratio format that matches the display aspect ratio format; and
if the display aspect ratio format is different from the first subtitle aspect ratio format, down-sampling or up-sampling the subtitle stream to have a second subtitle aspect ratio format that matches the display aspect ratio format.

30. The method of claim 29, wherein the first AV resolution format and the first subtitle resolution format are HD, the first AV aspect ratio format and the first subtitle aspect ratio format are 16:9, the display resolution is SD, and the display aspect ration is 4:3.

31. The method of claim 29, wherein when the AV stream is to be displayed in a letter box format, the subtitle aspect ration format is set to 16:9 and subtitles are displayed in black boarders of the letter box format on the display.
